(19) United States
(12) Patent Application Publication
(10) Pub. No.: US 2009/0100428 A1
(43) Pub. Date: Apr. 16, 2009

(54) RFID SYSTEM AND METHOD

(76) Inventors: Barry E. Willner, Briarcliff Manor, NY (US); Edith Helen Stern, Yorktown Heights, NY (US); Patrick Joseph O'Sullivan, Ballsbridge (IE); Robert Cameron Weir, Westford, MA (US)

Correspondence Address: HOLLAND & KNIGHT, 10 ST. JAMES AVENUE, BOSTON, MA, 02116-3889, US

(21) Appl. No.: 11/872,275

(22) Filed: Oct. 15, 2007

(51) Int. Cl. G06F 9/48

(52) U.S. Cl. 718/100

(57) ABSTRACT

A method and computer program product for obtaining a token identifier from a token device using a token reading system coupled to a local computing device. A determination is made concerning whether the token identifier obtained is associatable with a defined workflow. If the token identifier obtained is associatable with a defined workflow, at least a portion of the defined workflow is executed on the local computing device.

### TECHNICAL FIELD

This disclosure relates to RFID systems and, more particularly, to RFID systems for use in conjunction with personal computer systems.

### BACKGROUND

When using a personal computer, it often takes multiple steps to perform just about any function. Examples of such multi-step functions may include but are not limited to launching a web browser, navigating to a website, and checking your email. In the past, computer systems utilized shortcuts in the form of program function (i.e., PF) keys. For example, a dedicated key (or a combination of general purpose keys) may be configured to e.g., launch a program and/or execute a script, thus facilitating the execution of complex functions by selecting a single key (or a combination of keys). For example, a file editor may be launched with one key and an email client application may be launched with another key. One shortcoming of this methodology of launching programs and/or executing scripts is the limited number of keys available on a keyboard. Also, as the key might only include the workflow automation “F1”, the memory of the user is relied upon.

Voice recognition may be viewed as extending program function keys. The number of words that can be recognized is greater than the number of keys on the key board. Further, saying “editor” may be easier to remember than remembering the “F1” function key. A limitation of voice recognition may be that you need to know what to say. Accordingly, you must know what the commands are, the order to invoke the commands, and the relevant parameters of the commands (e.g., the URLs associated with each command). Additionally, voice recognition may require considerable training and the recognition programs may need to be tuned to specific languages and accents. For example, a non-native speaker of English may have difficulty in using speech recognition programs developed for native English speakers. Further, individuals with speech impediments and stroke survivors, for example, may have difficulty in using speech recognition programs.

Additionally, while systems have been developed in which e.g., a uniform resource locator is embedded within an RFID tag, these systems tend to be rudimentary in that the RFID tag might merely define a URL and does not define a workflow (e.g., does not perform the functional equivalent of one of the above-described function keys).

### SUMMARY OF DISCLOSURE

In a first implementation, a method includes obtaining a token identifier from a token device using a token reading system coupled to a local computing device. A determination is made concerning whether the token identifier obtained is associatable with a defined workflow. If the token identifier obtained is associatable with a defined workflow, at least a portion of the defined workflow is executed on the local computing device.

One or more of the following features may be included. The token reading system may be chosen from the group consisting of: a wireless token reading system; a radio frequency token reading system; and a magnetic token reading system. The defined workflow may be modified.

The workflow may be executed exclusively on the local computing device. The workflow may be executed at least partially on a remote computing device. The workflow may include one or more of the following: opening an application; closing an application; visiting a website; utilizing a username and/or password; executing an automated shutdown procedure; executing a maintenance procedure; executing an automated backup procedure; executing an automated restore procedure; executing an email composition procedure; executing an email reading procedure; and executing a file transfer procedure from a remote device to the local computing device.

The token device may be chosen from the group consisting of: an RFID tag; a magnetically-encoded card; a piece of jewelry; a key fob; and a card. If the token identifier obtained is not associatable with a defined workflow, the token identifier may be associated with a newly-defined workflow executable, at least in part, on the local computing device.

The newly-defined workflow may be defined. Defining a newly-defined workflow may include one or more of: determining an application to be opened; determining an application to be closed; determining a website to be visited; determining a username and/or password to be utilized; determining an automated shutdown procedure; determining a maintenance procedure; determining an automated backup procedure; determining an automated restore procedure; determining an email composition procedure; determining an email reading procedure; and determining a file transfer procedure from a remote device to the local computing device.

A new workflow may be defined. The new workflow may be associated with an unused token identifier.

In another implementation, a computer program product resides on a computer readable medium that has a plurality of instructions stored on it. When executed by a processor, the instructions cause the processor to perform operations including obtaining a token identifier from a token device using a token reading system coupled to a local computing device. A determination is made concerning whether the token identifier obtained is associatable with a defined workflow. If the token identifier obtained is associatable with a defined workflow, at least a portion of the defined workflow is executed on the local computing device.

One or more of the following features may be included. The token reading system may be chosen from the group consisting of: a wireless token reading system; a radio frequency token reading system; and a magnetic token reading system. The defined workflow may be modified.

The workflow may be executed exclusively on the local computing device. The workflow may be executed at least partially on a remote computing device. The workflow may include one or more of the following: opening an application; closing an application; visiting a website; utilizing a username and/or password; executing an automated shutdown procedure; executing a maintenance procedure; executing an automated backup procedure; executing an automated restore procedure; executing an email composition procedure; executing an email reading procedure; and executing a file transfer procedure from a remote device to the local computing device.

The token device may be chosen from the group consisting of: an RFID tag; a magnetically-encoded card; a piece of jewelry; a key fob; and a card. If the token identifier obtained is not associatable with a defined workflow, the token identifier may be associated with a newly-defined workflow executable, at least in part, on the local computing device.

The newly-defined workflow may be defined. Defining a newly-defined workflow may include one or more of: determining an application to be opened; determining an application to be closed; determining a website to be visited; determining a username and/or password to be utilized; determining an automated shutdown procedure; determining a maintenance procedure; determining an automated backup procedure; determining an automated restore procedure; determining an email composition procedure; determining an email reading procedure; and determining a file transfer procedure from a remote device to the local computing device.

A new workflow may be defined. The new workflow may be associated with an unused token identifier.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a workflow automation process coupled to a distributed computing network;

FIG. 2 is a diagrammatic view of a local computing device configured to execute the workflow automation process of FIG. 1; and

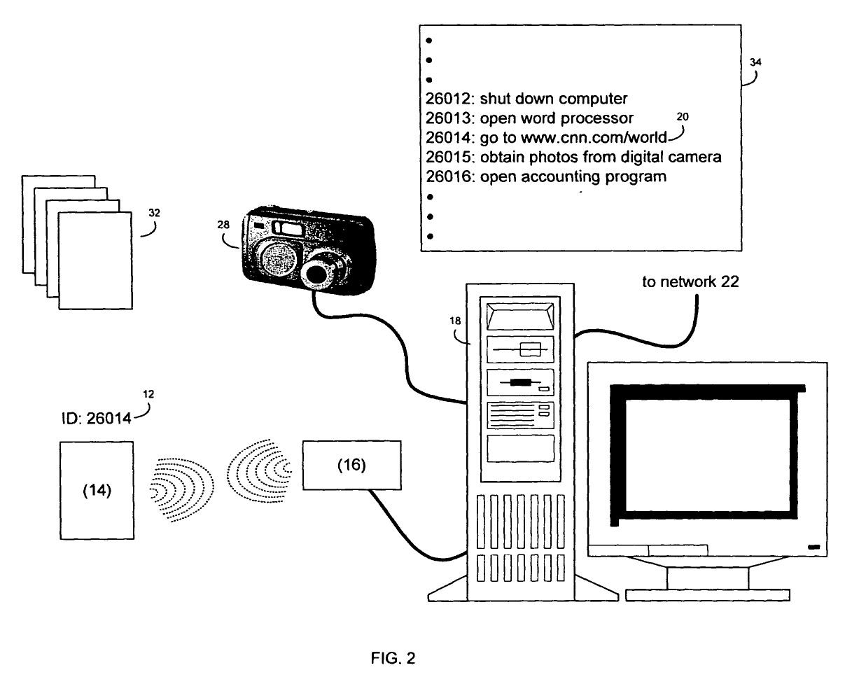

FIG. 3 is a flowchart of a process executed by the workflow automation process of FIG. 1.

Like reference symbols in the various drawings indicate like elements.

### DETAILED DESCRIPTION OF THE PREFERRED EMBODIMENTS

### System Overview:

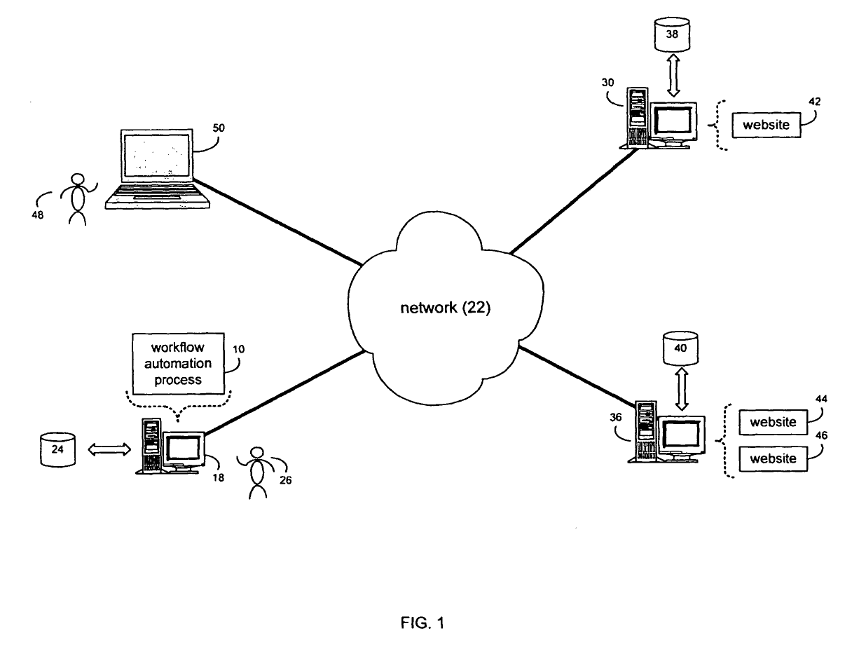

Referring to FIGS. 1 & 2, there is shown a workflow automation process 10. As will be discussed below, workflow automation process 10 may obtain token identifier 12 from token device 14 using token reading system 16 coupled to local computing device 18. A determination is made concerning whether token identifier 12 obtained from token device 14 is associatable with a defined workflow (e.g., defined workflow 20). If the token identifier (e.g., token identifier 12) obtained is associatable with a defined workflow (e.g., defined workflow 20), at least a portion of the defined workflow is executed on local computing device 18.

Workflow automation process 10 may reside on and may be executed by local computing device 18, which may be connected to network 22 (e.g., the Internet or a local area network). Examples of local computing device 18 may include, but are not limited to: a personal computer, a laptop computer, a notebook computer, a personal digital assistant, a dedicated network device, and a data-enabled cellular telephone. Local computing device 18 may execute an operating system, examples of which may include but are not limited to Microsoft Windows™, Microsoft Windows CE™, Redhat Linux™, or a custom operating system.

The instruction sets and subroutines of workflow automation process 10, which may be stored on storage device 24 coupled to local computing device 18, may be executed by one or more processors (not shown) and one or more memory architectures (not shown) incorporated into local computing device 18. Storage device 24 may include but is not limited to: a hard disk drive; a tape drive; an optical drive; a RAID array; a random access memory (RAM); a read-only memory (ROM), a compact flash (CF) storage device, a secure digital (SD) storage device, and a memory stick storage device.

### The Workflow Automation Process:

User 26 may use local computing device 18 to perform a plurality of tasks. Examples of such tasks may include but are not limited to: opening an application (e.g., opening a word processor program to compose a letter); closing an application (e.g., closing a word processor after the letter is composed); visiting a website (e.g., visiting a national news website or a niche' news website); utilizing a username and/or password (e.g., entering a username and password to access a membership-based website); executing an automated shutdown procedure (e.g., to shut down local computing device 18 in an orderly fashion); executing a maintenance procedure (e.g., executing a program that defragments a hard disk drive); executing an automated backup procedure (e.g., executing a program that backs up copies of digital photographs); executing an automated restore procedure (e.g., executing a program that restores copies of digital photographs that were deleted/corrupted); executing an email composition procedure (e.g., executing an email editor program to compose an email); executing an email reading procedure (e.g., logging onto a web-based email website to read email); and executing a file transfer procedure from a remote device to the local computing device (e.g., executing a program that downloads digital photographs from digital camera 28 coupled to local computing device 18).

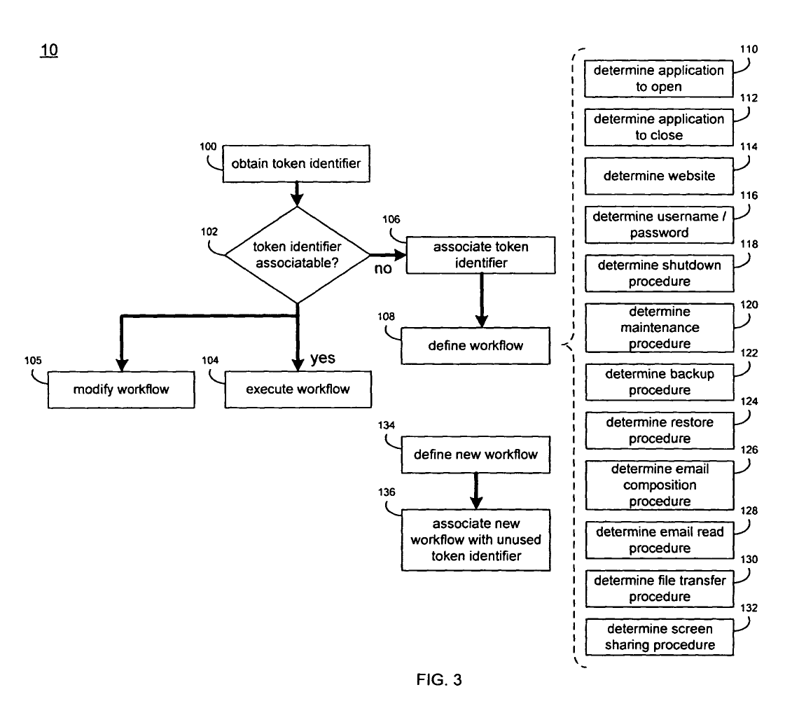

Referring also to FIG. 3, workflow automation process 10 may obtain 100 token identifier 12 from token device 14 using token reading system 16 coupled wired or wirelessly, to local computing device 18.

Examples of token device 14 may include but are not limited to: an RFID tag; a magnetically-encoded card; a barcode; a piece of jewelry (containing e.g., an RFID tag); a key fob (containing e.g., an RFID tag and/or a barcode); and a card (containing e.g., an RFID tag and/or a barcode). For example, a user may have a plurality of cards (e.g., that may resemble common playing cards). However, as with the above-described key fob, each of these cards may contain an RFID tag and/or a barcode that is associatable with a defined workflow. Accordingly, when a user wishes to execute a specific workflow, the user may simply select the card associated with that specific workflow and have the e.g., RFID tag and/or a barcode read by token reading system 16.

Examples of token reading system 16 may include wireless token reading systems and magnetic token reading systems.

An example of a wireless token reading system may include a Radio-Frequency Identification (RFID) system. As is known in the art, an RFID system is an automatic identification system that stores data on RFID tags (i.e., transponders) for subsequent retrieval using RFID readers. An RFID tag is an object that may be adhered to (or incorporated within) a product, an animal, or a person for the purpose of subsequently identifying the product, animal or person.

An RFID tag may contain (a) an integrated circuit for e.g., storing/processing information and modulating/demodulating a radio-frequency (RF) signal; and (b) an antenna assembly for receiving a signal (from the RFID reader) and transmitting a signal (to the RFID reader).

Another example of a wireless token reading system may include a barcode reading system that is configured to read a barcode printed upon e.g., a plastic card or a key fob. The barcode may include data that is decodable by the barcode reading system.

An example of a magnetic token reading system may include a magnetic card reading system for reading magnetic stripe cards. A magnetic stripe card is a type of card capable of storing data by modifying the magnetism of tiny iron-based magnetic particles within a band of magnetic material included on the card. The magnetic stripe card may be read by physically swiping the card past a reading head (included within the magnetic card reading system) capable of reading the data encoded within the magnetic material.

According, while using local computing device 18, user 26 may e.g., position an RFID tag (i.e., token device 14) proximate RFID reader (i.e., token reading system 16) so that workflow automation process 10 may obtain 100 token identifier 12 from token device 14 using token reading system 16, which is coupled to local computing device 18. For illustrative purposes, token identifier 12 is illustrated as “ID: 26014”.

Upon obtaining 100 the “ID: 26014” token identifier 12 from token device 14, workflow automation process 10 may determine 102 whether token identifier 12 is associatable with a defined workflow. If the token identifier obtained 100 (e.g., token identifier 12) is associatable with a defined workflow, at least a portion of the defined workflow may be executed 104 on local computing device 18. As will be discussed below in greater detail, the workflow may be executed exclusively on local computing device 18 or at least partially on a remote computing device (e.g., server computer 30).

Examples of a workflow may include but are not limited to: opening an application; closing an application; visiting a website; utilizing a username and/or password; executing an automated shutdown procedure; executing a maintenance procedure; executing an automated backup procedure; executing an automated restore procedure; executing an email composition procedure; executing an email reading procedure; and executing a file transfer procedure from a remote device to the local computing device.

Continuing with the above stated example, by utilizing a plurality of discrete token devices (e.g., plurality of discrete token devices 32), each of which includes a unique token identifier, user 26 may be able to choose from a plurality of available workflows by choosing the appropriate token device. For example: a first token identifier included within a first token device may open Microsoft Word™; a second token identifier included within a second token device may close Microsoft Word™ and may save any open documents for subsequent retrieval; a third token identifier included within a third token device may visit the “www.cnn.com/world” website (i.e., a news website concerning world events); a fourth token identifier included within a fourth token device may execute an automated shutdown procedure for computing device 18, resulting in all open files being saved, all open applications being closed, and computing device 18 being shut down in an orderly fashion. While this exemplary list of workflows is designed to be illustrative, it is not intended to be all inclusive. Accordingly, other workflows are considered to be within the scope of this disclosure.

Therefore, a token identifier included within a token device may be associated with a script and/or batch routine that: opens/closes one or more programs; saves/deletes one or more data files; backs up/restores one or more data files; accesses/logs on to one or more websites; and/or transfers data between devices. Accordingly, by selecting the appropriate token device, an appropriate workflow may be automatically initiated. Therefore, the process of executing a workflow may be automated, thus allowing people with minimal computer skills and/or compromised abilities to efficiently utilize e.g., local computing device 18.

Continuing with the above-stated example in which user 26 selects token device 14, which includes the “ID: 26014” token identifier 12. Upon obtaining 100 the “ID: 26014” token identifier 12 from token device 14, workflow automation process 10 may determine 102 whether token identifier 12 is associatable with a defined workflow by comparing the “ID: 26014” token identifier 12 with a plurality of token identifiers 34 defined within local computing device 18 and stored on e.g., storage device 24 that is coupled to local computing device 18. Alternatively, plurality of token identifiers 34 may be defined within a remote computing device (e.g., server computer 30 and/or server computer 36) and stored on e.g., storage device 38, 40 that is coupled to server computer 30, 36 (respectively).

Accordingly, token identifier 12 may be a piece of data (e.g., one or more numbers, one or more letters, or a combination thereof) that uniquely identifies token device 14. Upon obtaining 100 the “ID: 26014” token identifier 12 from token device 14, workflow automation process 10 may compare the “ID: 26014” token identifier to the plurality of token identifiers 34 to determine 102 whether the “ID: 26014” token identifier 12 is associatable with a defined workflow. In this particular example, plurality of token identifiers 34 is shown to include five unique token identifiers, namely: “ID: 26012”; “ID: 26013”; “ID: 26014”; “ID: 26015”; and “ID: 26016”. Each of these unique token identifiers is shown to be associated with a unique workflow, namely: “shut down computer”; “open word processor”; “go to www.cnn.com/world”; “obtain photos from digital camera”; and “open accounting program” (respectively).

As discussed above, if the token identifier obtained 100 (e.g., token identifier 12) is associatable with a defined workflow, at least a portion of the defined workflow may be executed 104 on local computing device 18. Continuing with the above-stated example, assume that the “ID: 26014” token identifier 12 is associated with workflow “go to www.cnn.com/world”. Accordingly, a workflow automation process 10 may execute a script in which a web browser (e.g., Microsoft Internet Explorer™) is launched and the “www.cnn.com/world” website 42 is accessed. When user 26 has reviewed the new articles that they are interested in, user 26 may select the token device that includes the “ID: 26012” token identifier, which initiates an orderly shutdown of local computing device 18.

In addition to executing 104 the associated workflow, workflow automation process 10 may allow a user to modify 105 the associated workflow, For example and as discussed above, workflow automation process 10 may automate the process of a user utilizing a username and/or password (e.g., entering a username and password to access a membership-based website). Accordingly, if the user changes their password while visiting the membership-based website, workflow automation process 10 may modify 105 the workflow associated with the token identifier obtained 100 to define the new password.

As discussed above, upon obtaining 100 a token identifier from a token device, workflow automation process 10 may determine 102 whether the token identifier is associatable with a defined workflow. If workflow automation process 10 determines 102 that the token identifier obtained 100 is not associatable with a defined workflow, the token identifier obtained 102 may be associated 106 with a newly-defined workflow executable, at least in part, on local computing device 18. Workflow automation process 10 may allow user 26 to define 108 this newly-defined workflow.

Examples of the types of workflows defined 108 may include but are not limited to: identifying 110 an application to be opened; identifying 112 an application to be closed; identifying 114 a website to be visited; identifying 116 a username and/or password to be utilized; identifying 118 an automated shutdown procedure; identifying 120 a maintenance procedure; identifying 122 an automated backup procedure; identifying 124 an automated restore procedure; identifying 126 an email composition procedure; identifying 128 an email reading procedure; identifying 130 a file transfer procedure from a remote device to the local computing device; and identifying 132 a screen sharing procedure.

When e.g., user 26 defines 108 a workflow, a workflow definition window (not shown) may be rendered by workflow automation process 10 that allows user 26 to e.g., define which applications to open/close; define which data files to save/delete; define which data files to back up/restore; define which websites to access/log on to; and/or define which data files to transfer between devices. Alternatively, user 26 may author a script (e.g., similar to a DOS batch routine) that defines the above-discussed procedures, and workflow automation process 10 may subsequently process this user-generated script at the time that the appropriate token device is selected by the user. Alternatively still, when defining a workflow, workflow automation process 10 may monitor the actions of a user (e.g., user 26) during a defined period of time and subsequently convert those actions into a workflow. For example, user 26 may instruct workflow automation process 10 to start monitoring the actions taken by user 26. User 26 may then e.g., launch a web browsing application; access a news website (e.g., www.foxnews.com); and execute the query “South American agricultural news”. User 26 may then instruct workflow automation process 10 to stop monitoring the actions taken by user 26. Workflow automation process 10 may then convert these monitored actions into a workflow, which user 26 may then assign to a unique token identifier included within a unique token device.

Additionally, workflow definition process 10 may allow a user to define 134 a new workflow, and may allow the user to associate 136 the new workflow with an unused token identifier. For example, assume that a financial management program introduces a new feature. When defining 134 the new workflow, workflow definition process 10 may monitor the use of this new feature and automatically define the workflow. Alternatively, the new workflow may be provided to workflow automation process 10 by e.g., the financial management program. Once the new workflow is defined 134, workflow automation process 10 may associate 136 the new workflow with an unused token identifier. For example, workflow automation process 10 may request that the user select e.g., an unused RFID tag, which may be scanned by token reading system 16. Once identified, workflow definition process 10 may associate 136 the unused token identifier (that is included within the unused RFID tag) with the new workflow.

As discussed above, the workflow may be executed exclusively on local computing device 18 or at least partially on a remote computing device (e.g., server computer 30). Accordingly, a workflow may be defined that requires at least partial remote execution. For example, assume that a work flow defines the following steps: a) launching a web browsing application; b) accessing a news website (e.g., website 44); and c) executing the query “high technology news eastern Europe” on the news website. Accordingly, while the web browsing application is executed locally on e.g., local computing device 18, the news website being accessed (e.g., website 44) is a remote website and the query is executed remotely on a remote web server (e.g., server computer 36).

In another example of a partial remote execution of a workflow, user 26 may select a token device that initiates an email composition procedure that utilizes a web-based email package (e.g., Google™ Mail or Yahoo™ Mail). Accordingly, by selecting the appropriate token device that includes the appropriate token identifier, a workflow may be initiated that a) launches a web browsing application; b) accesses email website 46; and c) opens an email composition window. User 26 may then compose an email to e.g., user 48, which user 48 may retrieve from email website 46 using computer 50. Accordingly, while the web browsing application is executed locally on e.g., local computing device 18, the email website (e.g., email website 46) being accessed is a remote website and the email is being composed remotely on a remote web server (e.g., server computer 36).

A number of implementations have been described. Nevertheless, it will be understood that various modifications may be made. Accordingly, other implementations are within the scope of the following claims.

What is claimed is:

1. A method comprising:
obtaining a token identifier from a token device using a token reading system coupled to a local computing device;
determining if the token identifier obtained is associatable with a defined workflow; and
if the token identifier obtained is associatable with a defined workflow, executing at least a portion of the defined workflow on the local computing device.

2. The method of claim 1 wherein the token reading system is chosen from the group consisting of: a wireless token reading system; a radio frequency token reading system; and a magnetic token reading system.

3. The method of claim 1 further comprising:
modifying the defined workflow.

4. The method of claim 1 wherein the workflow is executed exclusively on the local computing device.

5. The method of claim 1 wherein the workflow is executed at least partially on a remote computing device.

6. The method of claim 1 wherein the workflow includes one or more of the following:
opening an application
closing an application;
visiting a website;
utilizing a username and/or password;
executing a shutdown procedure;
executing a maintenance procedure;
executing an automated backup procedure;
executing an automated restore procedure;
executing an email composition procedure;
executing an email reading procedure;
executing a screen sharing procedure; and
executing a file transfer procedure from a remote device to the local computing device.

7. The method of claim 1 wherein the token device is chosen from the group consisting of: an RFID tag; a magnetically-encoded card; a piece of jewelry; a key fob; and a card.

8. The method of claim 1 further comprising:
if the token identifier obtained is not associatable with a defined workflow, defining a new workflow; and
associating the token identifier with a new workflow executable, at least in part, on the local computing device.

9. The method of claim 8 wherein defining a new workflow includes one or more of:
determining an application to be opened;
determining an application to be closed;
determining a website to be visited;
determining a username and/or password to be utilized;
determining an automated shutdown procedure;
determining a maintenance procedure;
determining an automated backup procedure;
determining an automated restore procedure;
determining an email composition procedure;
determining an email reading procedure;
determining a screen sharing procedure; and
determining a file transfer procedure from a remote device to the local computing device.

10. The method of claim 1 further comprising:
defining a new workflow; and
associating the new workflow with an unused token identifier.

11. A computer program product residing on a computer readable medium having a plurality of instructions stored thereon which, when executed by a processor, cause the processor to perform operations comprising:
obtaining a token identifier from a token device using a token reading system coupled to a local computing device;
determining if the token identifier obtained is associatable with a defined workflow; and
if the token identifier obtained is associatable with a defined workflow, executing at least a portion of the defined workflow on the local computing device.

12. The computer program product of claim 11 wherein the token reading system is chosen from the group consisting of: a wireless token reading system; a radio frequency token reading system; and a magnetic token reading system.

13. The computer program product of claim 11 further comprising instructions for:
modifying the defined workflow.

14. The computer program product of claim 11 wherein the workflow is executed exclusively on the local computing device.

15. The computer program product of claim 11 wherein the workflow is executed at least partially on a remote computing device.

16. The computer program product of claim 11 wherein the workflow includes one or more of the following:
opening an application;
closing an application;
visiting a website;
utilizing a username and/or password;
executing an automated shutdown procedure;
executing a maintenance procedure;
executing an automated backup procedure;
executing an automated restore procedure;
executing an email composition procedure;
executing an email reading procedure;
executing a screen sharing procedure; and
executing a file transfer procedure from a remote device to the local computing device.

17. The computer program product of claim 11 wherein the token device is chosen from the group consisting of: an RFID tag; a magnetically-encoded card; a piece of jewelry; a key fob; and a business card.

18. The computer program product of claim 11 further comprising instructions for:
if the token identifier obtained is not associatable with a defined workflow, defining a new workflow; and
associating the token identifier with the new workflow executable, at least in part, on the local computing device.

19. The computer program product of claim 19 wherein the instructions for defining a new workflow includes instructions for one or more of:
determining an application to be opened;
determining an application to be closed;
determining a website to be visited;
determining a username and/or password to be utilized;
determining an automated shutdown procedure;
determining a maintenance procedure;
determining an automated backup procedure;
determining an automated restore procedure;
determining an email composition procedure;
determining an email reading procedure;
determining a screen sharing procedure; and
determining a file transfer procedure from a remote device to the local computing device.

20. The computer program product of claim 1 further comprising instructions for:
defining a new workflow; and
associating the new workflow with an unused token identifier.
